(19) United States
(12) Patent Application Publication
(10) Pub. No.: US 2026/0211797 A1
(43) Pub. Date: Jul. 23, 2026

(54) METHOD AND APPARATUS FOR IMPROVING TEST CASE EFFICIENCY AT BUG DETECTION

(71) Applicant: Dell Products L.P., Round Rock, TX (US)

(72) Inventors: Changyue Dai, Chengdu (CN); Chi Chen, Chengdu (CN); Ping Gao, Chengdu (CN); En Shi, Chengdu (CN)

(21) Appl. No.: 19/094,426

(22) Filed: Mar. 28, 2025

(30) Foreign Application Priority Data
Jan. 22, 2025 (CN) 202510099804.X

(51) Int. Cl. G06F 11/3668

(52) U.S. Cl. CPC G06F 11/3672

(57) ABSTRACT

A method for testing operations of a system under test (SUT) includes obtaining, by a test evaluation system, an automation job request for implementing an automation job on the SUT, in response to the automation job request, obtaining a current state of the SUT, performing a factor analysis on the current state using a test result database to determine a set of factors that potentially contribute to a failure of the SUT, based on the set of factors, determining an action using an experience module and an exploration and exploitation trade-off (EET) value, modifying the automation job based on the action to obtain a new automation job, executing the new automation job on the SUT to obtain a result, calculating a reward corresponding to the result, and updating the experience module based on the reward, the current state, the action, and a new state of the SUT.

### BACKGROUND

Performing operations testing of a computing environment may require time and resources. During the operations testing, any number of factors may cause a failure in a system under test (such as the computing environment). Identifying the factors that cause the failure may be beneficial for the purposes of the operations testing. Discovering the factors during the operations testing may be a cumbersome task.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2A shows a diagram of a relationship between states, actions, and rewards in accordance with one or more embodiments of the invention.

FIG. 2B shows a diagram of an experience function in accordance with one or more embodiments of the invention.

FIGS. 3A-3B show a flowchart of a method for implementing and updating automation jobs for testing in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for managing the operations testing of computing environments such as, for example, storage devices. The operations testing may be managed by leveraging an automation job framework that executes the operations testing. Embodiments of the invention utilize reinforcement learning and a test results database to determine actions to be applied to the automation jobs to modify the operations testing for the purposes of identifying factors that affect the failure of the computing environments. Embodiments of the invention include functionality for monitoring the actions applied to modified automation jobs, identifying the impact of the modified automation jobs on the system under test (SUT), and determining, based on the state of the SUT, the actions applied to the automation jobs, and the result of implementing the modified automation jobs, optimal policies for future modifications. Such determinations of optimal policies may provide efficient operations testing of the SUTs to identify more failure points of the SUTs in fewer attempts.

Various embodiments of the invention are described below.

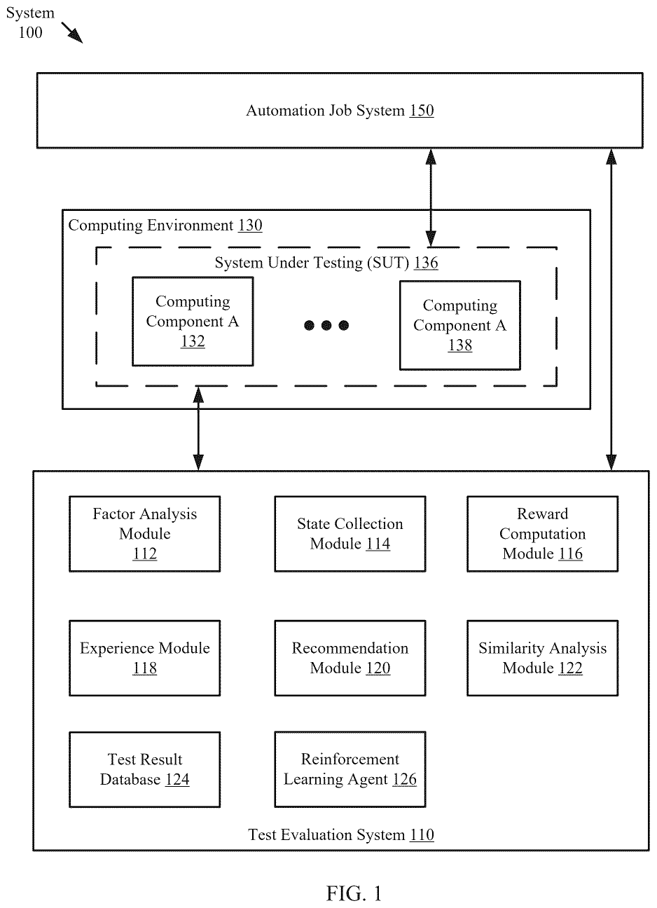

FIG. 1 shows a diagram of a system in accordance with one or more embodiments of the invention. The system (100) includes an automation job system (150), a computing environment (130), and a test evaluation system (110). The system (100) of FIG. 1 may include additional, different, and/or different components without departing from the invention.

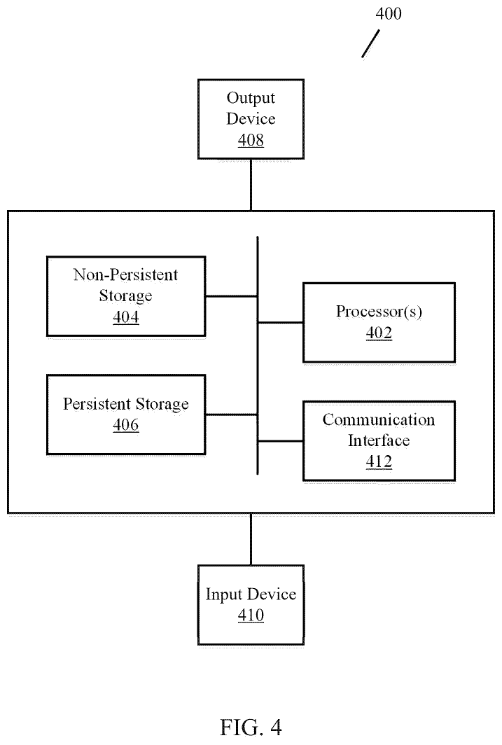

In one or more embodiments, the computing environment (130) includes functionality for providing computing services to users (not shown) or other entities. The computing environment (130) may be implemented as an environment of computing devices (see, e.g., FIG. 4). The computing devices may utilize any number of computing components (132, 138).

In one or more embodiments, at least a portion of the computing components (132, 138) of the computing environment (130) undergo operational testing. The portion of the computing components (132, 136) undergoing operational testing may be referred to as a system under test (SUT) (136). The SUT (136) may undergo operational testing as implemented by the automation job system (150) and the test evaluation system (110). For example, the SUT (136) may be implemented as a storage system in which the computing components (132, 138) are each a storage device that stores data generated or otherwise obtained from the computing environment (130).

In one or more embodiments, the computing environment (130) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the computing environment (130) described throughout this application.

In one or more embodiments disclosed herein, the computing environment (130) is implemented as a logical device. The logical device may utilize the computing resources of any number of computing devices and thereby provide the functionality of the computing environment (130) described throughout this application.

In one or more embodiments, the automation job system (150) includes functionality for executing the operational testing. Specifically, the automation job system (150) may include any computing resources for issuing, for example, input/output operations (IOPS), storage requests, and/or other read/write requests that apply computational load on the SUT (136). The issued IOPS (or other requests) by the automation job system (150) may be applied for the purpose of testing the operability of the SUT (136).

For example, the level of operations issued by the automation job system (150) may be high enough such that the operations cause the computational load of the SUT (136) to be to near or over its limit. As such, the SUT (136) may experience a failure (e.g., a failure in servicing the operations and/or requests). The failure may be caused by one or more operational issues (also referred to as bugs). The operational issues may be evaluated for the purposes of improving future iterations of the SUT (136).

A configuration (e.g., selection) of the operations to be implemented may impact the likelihood that a test case (e.g., a set of operations associated with a test for a given SUT (136) at a point in time) induces a failure in the SUT (136). As such, it may be beneficial to identify, through repeated testing, factors that contribute to the failure while minimizing the amount of testing performed.

To aid in increasing the identified set of factors while minimizing the number of tests, embodiments of the invention may utilize a test evaluation system (110). The test evaluation system (110) may include functionality for evaluating the configuration of test cases (also referred to as automation jobs) to determine a set of factors that limit the operability of the SUT (136). To perform such functionality, the test evaluation system (110) includes a factor analysis module (112), a state collection module (114), a reward computation module (116), an experience module (118), a recommendation module (120), a similarity analysis module (122), a test result database (124), and a reinforcement agent (126). The test evaluation system (110) may include additional, fewer, and/or different components without departing from the invention.

In one or more embodiments, the factor analysis module (112) analyzes which factors (also referred to as automation job parameters) contribute the most to a test failure. For different combinations of computing components in the computing environment (130) under test, different factor combinations may contribute to one or more bugs.

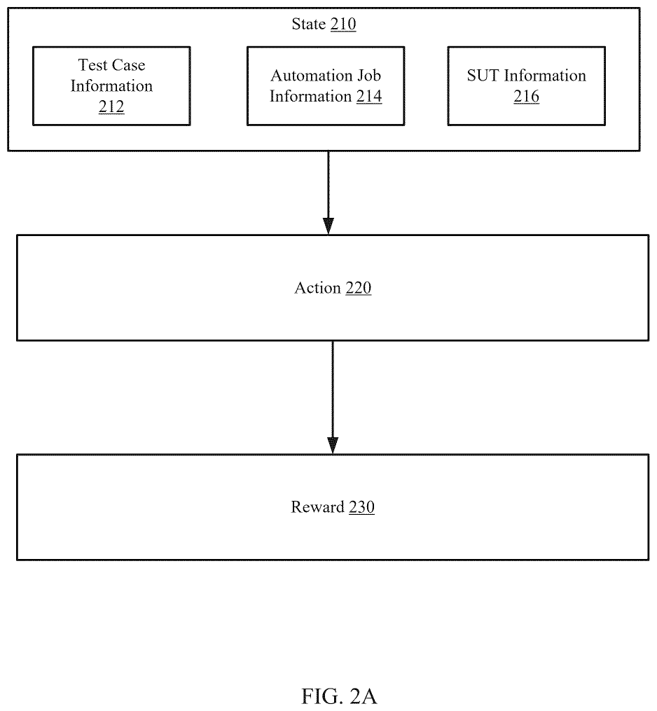

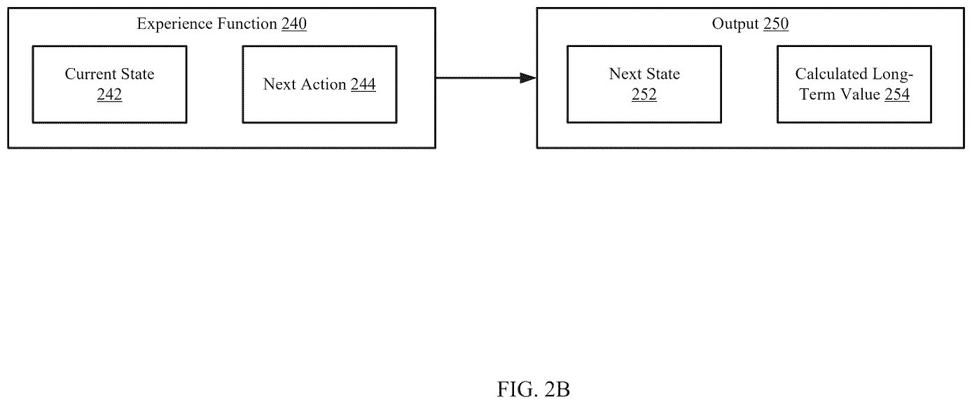

In one or more embodiments, the state collection module (114) obtains information associated with a state (discussed in FIG. 2A) of a test case from the automation job system (110) and/or the SUT (136).

In one or more embodiments, the reward computation module (116) includes functionality for calculating a reward of action (t) for a given test case (“t”) in state S (t) based on the goal of modifying the automation job in order to find critical bugs within fewer attempts and, as such, imposing a smaller computational cost.

In one or more embodiments, the experience module (118) applies an experience function according to the current state (“s”), an action (“a”), a reward and next state. The experience Q(s,a) is a mapping between a pair of states and actions to a maximum long term reward. For additional details regarding the experience function, refer to FIG. 2B.

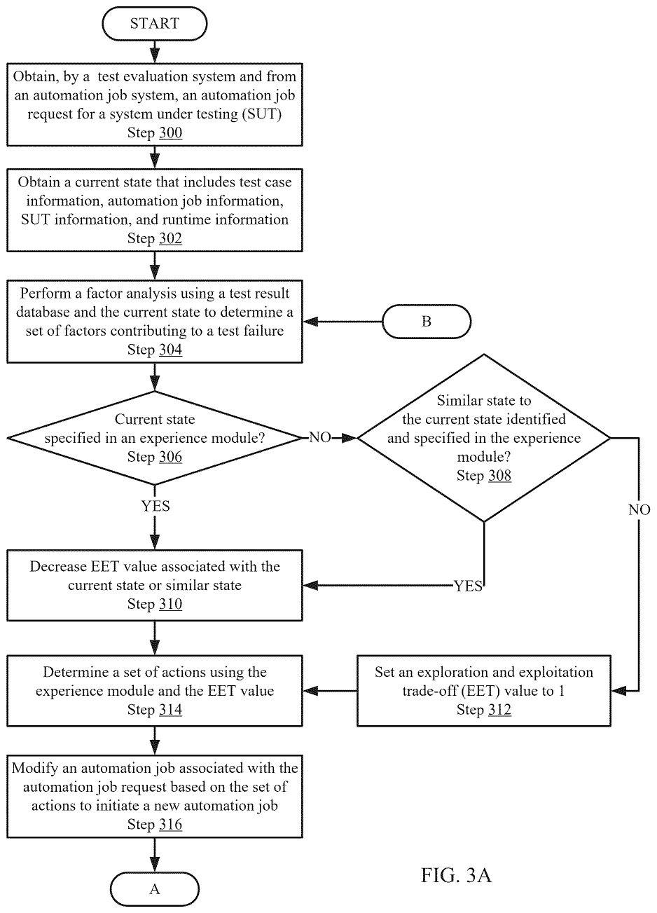

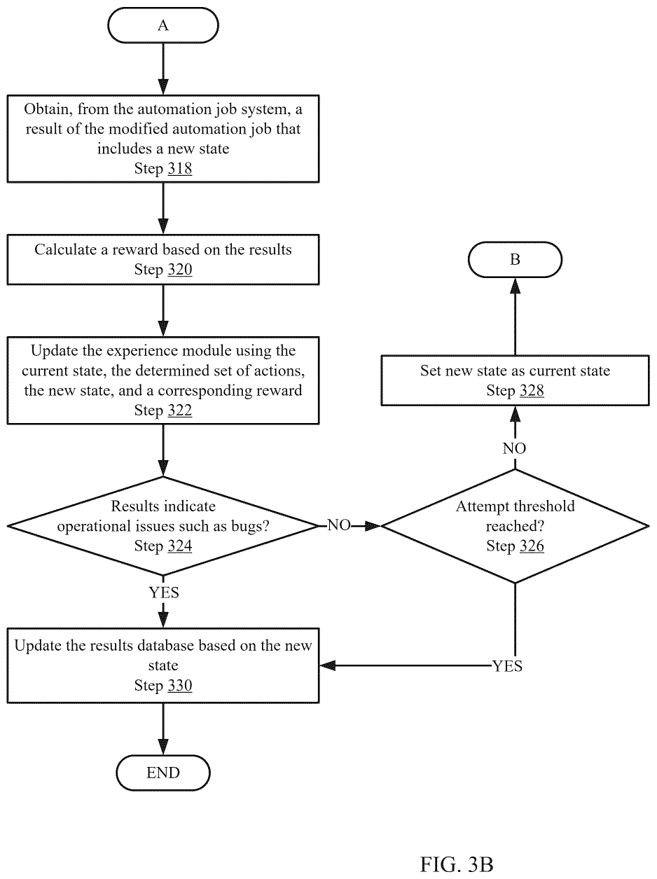

In one or more embodiments, the recommendation module (120) observes the current states (t) and provides a job modification action a (t) to the current automation job. For example, the recommendation module (120 may use the experience module to identify an action that maximizes reward. The recommendation module may recommend a next action by selecting between, for example: (i) the identified action, or (ii) a random action. The selection is further discussed in the method of FIGS. 3A-3B.

In one or more embodiments, the similarity analysis module (122) analyzes the similarity of two or more states. The similarity analysis module may determine a similarity value between a pair of states and, based on any predefined thresholds, may deem a pair of states as similar. The similarity value may be determined via any mechanism without departing from the invention.

In one or more embodiments, the test result database (124) stores information such as, for example, state information (defined in FIG. 2A) for a test case, test results of a corresponding automation job, runtime information of the automation job, and/or any other information deemed relevant for evaluating the SUT (136).

In one or more embodiments, the reinforcement agent (126) uses a reinforcement learning algorithm to update the experience function discussed throughout the present disclosure. The experience function may be updated based on, for example, the current state, an action (“a”), a reward for implementing the action to the current state, and a next state resulting from applying the action. Examples of reinforcement learning algorithms used for updating the experience function include, but are not limited to: a Q-learning algorithm, deep Q network (DQN) algorithm, and a double deep Q network (DDQN) algorithm. For additional details regarding calculating the reward, refer to FIG. 2A.

FIG. 2A shows a diagram of a relationship between a state, action, and reward in accordance with one or more embodiments of the invention. As discussed above, a state (210) may be associated with a test case. The state (210) may include, for example, test case information, automation job information, 214, and SUT information. The state (210) of a test case may include additional, fewer, and/or different information without departing from the invention.

In one or more embodiments, the test case information (212) relates to test case static information such as, for example, a test name, a test related feature, a test area, and test parameters.

In one or more embodiments, the automation job information (214) relates to automation job parameters (some of which may be changed using actions) that configure the set of operations implemented in a corresponding test.

In one or more embodiments, the SUT information (216) is a static value that relates to information about the computing components in the corresponding SUT. Examples of SUT information include hardware information, operating system information, firmware information, and/or other information without departing from the invention.

The SUT information (216) may further specify runtime information that relates to dynamic information of the SUT such as, for example, performance status, capacity usage status, a rounding value of average total IOPS, average CPU utilization, average latency, and average physical space usage during the execution of the automation job.

In one or more embodiments, the test evaluation system (110, FIG. 1) discussed above observes the current state (210) at each attempt and take an action (220) that specifies modifying one of the automation job parameters (214) of the current automation job.

In one or more embodiments, the result of applying the action (220) to the current state (210) may be used to calculate a reward (230). The reward (230) may represent a value relating to how much the action (220) leads to achieving the goal of causing a failure in the operability of the SUT. For example, the reward (210) may be based on a level of failure caused by the action and a testing cost (e.g., a value representing the amount of resources used to apply the action). As an example, a failure that results in critical bugs may result in a higher level of failure relative to a test that is not failed by the SUT. An intermediate level of failure may be one in which the test is failed with no critical bugs. A lowest level of failure may be one in which the test is passed without any error messages. The reward (210) may be calculated as a ratio of the level of failure to the testing cost.

FIG. 2B shows a diagram of an experience function in accordance with one or more embodiments of the invention. As discussed above, the experience function (240) is used by an experience module (118, FIG. 1). The experience function (240) may generate an output (250) based on an input that includes a current state (242), an action (also referred to as a next action) (244). The output (250) may include a next state (252) and a calculated long-term value (254). The next state (252) may represent an expected state resulting from applying the changes associated with the next action (244) to the current state (242). For example, as discussed in FIG. 2A, the action (210) may be a change to the automation job parameters of a state (242). The next state (252) may specify the information of the current state (242) with the updated automation job parameters replacing the previous automation job parameters.

The calculated long-term value (254) represents a maximum expected value that selecting the next action (244) to be performed on the current state (242) may result in achieving the goal of a failure by the corresponding SUT. For example, the next action (244) applied to a current state (242) may be associated with a high calculated long-term value (254) in a scenario in which the next action (244) leads the next state (252) in a direction that is highly likely to result in a failure. Conversely, the next action (244) applied to a current state (242) may be associated with a low calculated long-term value (254) in a scenario in which the next action (244) leads the next state (252) in a direction that is not particularly likely to result in a failure (or may require a significantly high computational cost to achieve failure).

FIGS. 3A-3B show a flowchart of a method for implementing and updating automation jobs for testing in accordance with one or more embodiments of the invention. The method shown in FIGS. 3A-3B may be performed by, for example, a test evaluation system (110, FIG. 1). Other components of the system illustrated in FIG. 1 may perform the method of FIGS. 3A-3B without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

The method of FIGS. 3A-3B may be performed for a set of automation jobs.

Turning to FIG. 3A, in step 300, an automation job request is obtained from an automation job system for testing a SUT.

In step 302, a current state of the test case is obtained. As discussed throughout the present disclosure, the state may include test case information for the most recent test applied to the SUT, the automation job parameters of the previous automation job, and the SUT information of the SUT.

In step 304, a factor analysis is performed using a test result database and the current state to determine a set of factors contributing to a test failure. In one or more embodiments, the factor analysis is performed by a factor analysis module. The factor analysis includes analyzing the test results database to analyze the factors (e.g., automation job parameters) contribute the most to the test failure. The factors may be determined using any machine learning algorithms without departing from the invention.

In one or more embodiments, following the factor analysis, an action space is updated to specify a list of actions that are impacted by the determined set of factors. For example, for an action space of all possible actions that may be applied to a given state, the factor analysis may result in reducing the action space to a portion of all possible actions that are associated with the determined set of factors. By updating the action space using the determined set of factors, the accuracy and speed of multiple iterations of testing is improved.

In step 306, a determination is made about whether the current state is specified in the experience module. In one or more embodiments, the determination of step 306 is based on whether there are any long-term values that could be determined using the current state applied to the experience function, for any possible action, at the current point in time. If the current state is specified in the experience module, the method proceeds to step 310; otherwise, the method proceeds to step 308.

In step 308, a determination is made about whether a similar state to the current state is identified and specified in the experience module. In one or more embodiments, the determination of step 308 is made using a similarity module that determines whether the current state is similar to another state that is specified in the experience module. If a similar state is available, the method proceeds to step 310; otherwise, the method proceeds to step 312.

In step 310, an exploration and exploitation (EET) value associated with the current state and/or similar state is decreased from a previous set value. In one or more embodiments, the EET value is a value between 0 and 1 that represents a probability that the next action to be determined (e.g., in step 314 below) is a random action. The EET value may be a high value for states that have not been attempted often, thus inducing exploration of the possible actions and learning from the results. In contrast, for states that have been tested a significant number of times, the EET value may be relatively lower, thus inducing the exploitation of known actions that achieve a desired goal of operational issues (or failure) in the SUT. As such, the test evaluation system leverages exploration (higher EET value) for newer, less tested states, and leverages exploitation (lower EET value) for more tested states. The EET value may be decreased for the next iteration of testing.

In step 312, following the determination that the current state and a similar state are not specified in the experience module, the EET value is set to 1 (or 100%). As discussed above, the higher EET value may be associated with states that have been tested less than states with lower EET values. As such, given the current state is not specified in the experience module and thus has not been tested, the EET value is set to the highest value (e.g., 1) to induce exploration of possible actions.

In step 314, an action is determined using the experience module and the EET value. In one or more embodiments, the action is determined by identifying the known action for the given current state that provides the highest long-term value, and applying a probability of the current set EET value that a random action is determined. If the probability of selecting a random action is met, the random action is the determined action; otherwise, the known action is the determined action.

In step 316, an automation job associated with the automation job request is modified based on the determined action to initiate a new automation job. In one or more embodiments, the automation job is modified by applying the determined action (e.g., either the known action that maximizes long-term value or a random action) determined in step 314 to the automation job parameters of the current state to obtain the new automation job.

The new automation job may be initiated by issuing the new automation job to be executed by the automation job system on the SUT. The automation job system executes the new automation job on the SUT.

Turning to FIG. 3B, following the execution of the new automation job discussed above, in step 318, results of the new automation job is obtained. The results may specify information such as whether operational issues were introduced in the SUT, whether the execution of the automation job is successfully performed, whether any errors were introduced, and/or any other information specifying the result of applying the automation job on the SUT.

In step 320, a reward is calculated based on the results. In one or more embodiments, the reward is calculated as discussed in FIG. 2A using the current state, the results obtained in step 318, and the computing cost of applying the new automation job.

In step 322, the experience module is updated using the current state, the determined set of actions, the new state after applying the set of actions, and the calculated reward. In one or more embodiments, the results (e.g., whether a failure occurred, a critical failure, or a success is specified in the results), the calculated reward, the current state, the new state, and the determined action are used to update the experience module. For example, the experience module is updated using a reinforcement learning algorithm to approximate an optimal policy. As such, the experience function gains accuracy over multiple iterations of state, action, reward relationships.

In step 324, a determination is made about whether the obtained results indicate operational issues such as bugs in the SUT. If operational issues are indicated, the method proceeds to step 330; otherwise, the method proceeds to step 326.

In step 326, following the determination that no operational issues were caused by the results of the new automation job, another determination is made about whether an attempt threshold is reached for attempting to cause operational issues in the SUT. If the attempts threshold is reached, the method proceeds to step 330; otherwise, the method proceeds to step 328.

In step 328, the new state is set as the current state. Following step 328, the method returns to step 304 in FIG. 3A for another attempt to cause operational failures and evaluate the determined action(s) for the next state of the test case. As such, multiple iterations of testing may be performed on the SUT for additional actions until either a failure occurs (e.g., via operational issues detected in the results) or the attempt threshold is met.

In step 330, following the determination that an operational issue is caused, or an attempt threshold is met, the test results database is updated based on the results and the new state. In this manner, future iterations of automation jobs may use the updated test results database to determine factors that contribute to failures in future tests.

### Example

To clarify aspects of the invention, the following describes an example in accordance with one or more embodiments of the invention. Turning to the example, consider a scenario in which a system under test (SUT) includes a storage system of storage devices designed for storing large volumes of data.

An example state similar to one discussed in FIG. 2A may include the following information: a test name “Test Name: Test_QC112047_BasicMetroTest”, a test feature being “Metro Replication”, a test area of “Basic Life cycle test”, a session number “10”, an operating system of “Linux”. The automation job information includes parameters such as a number of cycles, a load profile, a load type, a volume number, a prefill percentage, and a local protection policy. Said another way, the test will repeat a defined number of cycles, apply a pre-defined load profile, create a number of volumes, consume the prefill percentage of the SUT storage capacity, and each volume will configure a local protection policy using the predefined load type. These automation job parameters may be modified for evaluation to determine how they impact the operability of the SUT.

Additional SUT information includes the system hardware, a system platform, and drive information of the SUT. For a given set of automation job parameters, the SUT information further includes dynamic information such as average total IOPS, average central processing unit (CPU) utilization percentage, average latency of IOPS, and average physical space usage.

To define the action space, the following table is used to define a set of automation job parameters in each row and defined state spaces and potential actions for each parameter:

TABLE 1
automation job parameters and corresponding possible actions.

| Automation | | | | |
|---|---|---|---|---|
| Job | Parameter | State | How To | |
| Parameters | Identifier | Space | Change | Action |
| Prefill | P1 | [0, 5, 10, | Increase | Increase the current |
| | | 15, . . . , | by 5 | state in order to get |
| | | 95] | | next parameter |
| Cycles | P2 | 1 to 100 | Increase | Increase the current |
| | | | by 1 | state in order to get |
| | | | | next parameter |
| Volume | P3 | [10, 15, | Increase | Increase the current |
| Number | | 20, . . . , | by 5 | state in order to get |
| | | 200] | | next parameter |
| Local | P4 | Acceptable | Next | From the acceptable |
| Protection | | Local | acceptable | list, move from |
| Policy | | protection | value | current value to next |
| | | policy list | | value |
| LOAD | P5 | Acceptable | Next | From the acceptable |
| TYPE | | IO tool list | acceptable | list, move from |
| | | | value | current value to next |
| | | | | value |
| LOAD | P6 | Acceptable | Next | From the acceptable |
| PROFILE | | IO pattern | acceptable | list, move from |
| | | list | value | current value to next |
| | | | | value |

In this example, the acceptable local protection policy list includes the following: none, once a day, every 16 hours, every 8 hours, every 4 hours, every 2 hours, every hour, and every 30 minutes.

The acceptable IO tool list includes the following: vdbench, fio, dcb, iometer.

The acceptable IO pattern list includes the following: profile1, profile2, profile3, profile 4.

The following table lists each possible action to be taken to a current set of automation job parameters:

TABLE 2
list of actions and modifications to the automation jobs

| Actions | Automation Job Modification | New Automation Job |
|---|---|---|
| 1 | No action | {p1, p2, p3, p4, p5, p6} |
| 2 | p1 <- P1 + 5 | {p1 + 5, P2, p3, P4, p5, p6} |
| 3 | p2 <- p2 + 1 | {p1, p2 + 1, p3, p4, p5, p6} |
| 4 | P3 <- p3 + 5 | {p1, p2, p3 + 5, p4, p5, p6} |
| 5 | P4 <- P4′ | {p1, p2, p3, p4′, p5, p6} |
| | In Acceptable Local protection | |
| | policy list, move from current | |
| | value to next value. | |
| 6 | P5 <- P5′ | {p1, p2, p3, p4, p5′, p6} |
| | In Acceptable LOAD_TYPE | |
| | list, move from current value to | |
| | next value. | |
| 7 | P6 <- P6′ | {p1, p2, p3, p4, p5, p6′} |
| | In acceptable LOAD_PROFILE | |
| | list, move from current value to | |
| | next value. | |

As illustrated above, each action represents modifying one of the automation job parameters, such as the cycles, prefill, load profile, etc. Table 2 above is an example action space of possible actions that may be applied to the state in each iteration of testing. After a factor analysis in accordance with step 304 of FIG. 3A is applied, a set of factors may be determined that are deemed likely to impact the testing to increase the chance of inducing a failure in the SUT. In this example, for a first iteration of a factor analysis, the factors determined to impact the testing may be the number of cycles (p2), the load profile (p6), and the local protection policy (p4). As such, the action space illustrated in Table 2 may be updated to list a portion of the possible actions that impact the determined factors of p2, p4, and p6. Accordingly, the action space may be updated to include only actions 1, 3, 5, and 7. For each iteration of testing, the action space is updated to accurately reflect the list of actions likely to produce a favorable result.

The method of FIGS. 3A-3B is performed to test the example SUT starting with a current state that includes the following parameters: P1: 10%; P2: 5; P3: 10; P4: once a day; P5: vdbench; P6: profile 1.

For each iteration of testing, an action, selected from the updated action space, may be applied to the state that includes modifying one of the P1-P6 parameters in accordance with Table 2. A result may include a determination about whether a failure occurs, whether operational issues such as critical or non-critical bugs occur, and/or whether error messages are issued.

To calculate the reward for each state, the following table maps a set of results to a corresponding test result score:

TABLE 4
Test status and corresponding test result score.

| Test Status | Test Result Score |
|---|---|
| failed with critical bugs | 10 |
| failed with bugs | 8 |
| pass with performance | 6 |
| degrade | |
| pass with error message | 5 |
| found in the system logs | |
| pass without any error and | −5 |
| performance degrade | |

As illustrated in Table 4, a failure with critical bugs is mapped to the highest test result score, and a pass (e.g., no failure) without any error messages or operational issues is mapped to a negative reward, as it is undesirable in testing the operability of the SUT to not be near the load limit.

In this example, the reward is calculated as a ratio of the test result score to a computation cost of implementing the automation job. The computation cost may be calculated as follows: Cost=W1*P1+W2*P2+W3*P3+W3*P3+W4*P4+W5*P5, where each of the parameters P1 to P5 correspond to a numerical value of one of the automation job parameters as defined in Table 1, and each of the weights W1 to W5 is a predefined value that is based on the respective impact that a corresponding parameter affects the computation cost.

To determine a next action for the testing, the test evaluation system applies the experience function on each state for a given action to calculate an expected long-term value that the action results in achieving the goal.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention enable efficient data management of a distributed namespace (DNS) by processing a large number of pages from multiple snapshots of the DNS. The efficient data management is enabled by assigning a subset of all pages to each of a plurality of computing nodes for parallel processing. Embodiments of the invention reduce the use of logical walks of the assigned pages by determining a subset of the assigned pages that is used for physical enumeration. To prevent redundancies in physical enumeration of pages, embodiments provide an algorithm for determining the subset of the assigned pages by not including any pages that are not referenced in dataful snapshots, and filtering those referenced by multiple snapshots such that only one of the computing nodes includes a given page in the subset of pages for physical enumeration. By providing a method for enabling parallel processing of a DNS while reducing redundancies, embodiments of the invention improve the operation of the computing devices by efficiently managing computing resource use by a DNS system of computing devices providing services using the DNS.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for testing operations of a system under test (SUT), the method comprising:
obtaining, by a test evaluation system, an automation job request for implementing an automation job on the SUT;
in response to the automation job request, obtaining a current state of the SUT;
performing a factor analysis on the current state using a test result database to determine a set of factors that potentially contribute to a failure of the SUT;
based on the set of factors, determining an action using an experience module and an exploration and exploitation trade-off (EET) value,
wherein the experience module indicates a long-term value for performing the action at the current state,
wherein the EET value corresponds to a likelihood that the action that is determined is random, and
wherein the long-term value corresponds to a value indicating an expected outcome that the SUT undergoes the failure when the action is performed at the current state;
modifying the automation job based on the action to obtain a new automation job;
executing the new automation job on the SUT to obtain a result;
calculating a reward corresponding to the result; and
updating the experience module based on the reward, the current state, the action, and a new state of the SUT.

2. The method of claim 1, further comprising:
after updating the experience module; making a determination that an attempt threshold has not been reached;
based on the determination, performing the factor analysis on the new state to determine a new set of factors;
determining a new EET value based on the new state;
determining a second action using the experience module, the new state, and the new EET value;
modifying the new automation job based on the second action to obtain a third automation job;
executing the third automation job on the SUT to obtain a second result;
calculating a second reward corresponding to the second result; and
updating the experience module based on the second reward, the new state, the second action, and a third state of the SUT.

3. The method of claim 1, wherein the SUT is a storage system comprising one or more storage devices.

4. The method of claim 1, wherein the current state is not specified in the experience module, and wherein a similar state specified in the experience module is used to determine the action.

5. The method of claim 1, wherein the current state is not specified in the experience module, wherein a similar state is not specified in the experience module, and wherein the EET value is set to 100%.

6. The method of claim 1, wherein the result indicates the failure of the SUT, and wherein the test result database is updated to specify the failure, the current state, and the action.

7. The method of claim 1, wherein the current state comprises test case information, automation job information, and SUT information.

8. The method of claim 7, wherein the set of factors correspond to a portion of the automation job information, and wherein the action corresponds to modifying at least one of the set of factors in the automation job specified in the automation job information.

9. A non-transitory computer readable medium comprising computer readable program code, which when executed by a computer processor enables the computer processor to perform a method for testing operations of a system under test (SUT), the method comprising:
obtaining, by a test evaluation system, an automation job request for implementing an automation job on the SUT;
in response to the automation job request, obtaining a current state of the SUT;
performing a factor analysis on the current state using a test result database to determine a set of factors that potentially contribute to a failure of the SUT;
based on the set of factors, determining an action using an experience module and an exploration and exploitation trade-off (EET) value,
wherein the experience module indicates a long-term value for performing the action at the current state,
wherein the EET value corresponds to a likelihood that the action that is determined is random, and
wherein the long-term value corresponds to a value indicating an expected outcome that the SUT undergoes the failure when the action is performed at the current state;
modifying the automation job based on the action to obtain a new automation job;
executing the new automation job on the SUT to obtain a result;
calculating a reward corresponding to the result; and
updating the experience module based on the reward, the current state, the action, and a new state of the SUT.

10. The non-transitory computer readable medium of claim 9, further comprising:
after updating the experience module; making a determination that an attempt threshold has not been reached;
based on the determination, performing the factor analysis on the new state to determine a new set of factors;
determining a new EET value based on the new state;
determining a second action using the experience module, the new state, and the new EET value;
modifying the new automation job based on the second action to obtain a third automation job;
executing the third automation job on the SUT to obtain a second result;
calculating a second reward corresponding to the second result; and
updating the experience module based on the second reward, the new state, the second action, and a third state of the SUT.

11. The non-transitory computer readable medium of claim 9, wherein the SUT is a storage system comprising one or more storage devices.

12. The non-transitory computer readable medium of claim 9, wherein the current state is not specified in the experience module, and wherein a similar state specified in the experience module is used to determine the action.

13. The non-transitory computer readable medium of claim 9, wherein the current state is not specified in the experience module, wherein a similar state is not specified in the experience module, and wherein the EET value is set to 100%.

14. The non-transitory computer readable medium of claim 9, wherein the result indicates the failure of the SUT, and wherein the test result database is updated to specify the failure, the current state, and the action.

15. The non-transitory computer readable medium of claim 9, wherein the current state comprises test case information, automation job information, and SUT information.

16. The non-transitory computer readable medium of claim 15, wherein the set of factors correspond to a portion of the automation job information, and wherein the action corresponds to modifying at least one of the set of factors in the automation job specified in the automation job information.

17. A system comprising:
a test evaluation system, operating on a processor;
a system under test (SUT), wherein the SUT is a storage system comprising one or more storage devices; and
memory comprising instructions, which when executed by the processor, perform a method comprising:
obtaining an automation job request for implementing an automation job on the SUT;
in response to the automation job request, obtaining a current state of the SUT, wherein the current state comprises test case information, automation job information, and SUT information;
performing a factor analysis on the current state using a test result database to determine a set of factors that potentially contribute to a failure of the SUT;
based on the set of factors, determining an action using an experience module and an exploration and exploitation trade-off (EET) value,
wherein the action corresponds to modifying at least one of the set of factors in the automation job,
wherein the experience module indicates a long-term value for performing the action at the current state,
wherein the EET value corresponds to a likelihood that the action that is determined is random, and
wherein the long-term value corresponds to a value indicating an expected outcome that the SUT undergoes the failure when the action is performed at the current state;
modifying the automation job based on the action to obtain a new automation job;
executing the new automation job on the SUT to obtain a result,
wherein the result indicates the failure of the SUT, and wherein the test result database is updated to specify the failure, the current state, and the action;
calculating a reward corresponding to the result; and
updating the experience module based on the reward, the current state, the action, and a new state of the SUT.

18. The system of claim 17, further comprising:
after updating the experience module; making a determination that an attempt threshold has not been reached;
based on the determination, performing the factor analysis on the new state to determine a new set of factors;
determining a new EET value based on the new state;
determining a second action using the experience module, the new state, and the new EET value;
modifying the new automation job based on the second action to obtain a third automation job;
executing the third automation job on the SUT to obtain a second result;
calculating a second reward corresponding to the second result; and
updating the experience module based on the second reward, the new state, the second action, and a third state of the SUT.

19. The system of claim 17, wherein the current state is not specified in the experience module, and wherein a similar state specified in the experience module is used to determine the action.

20. The system of claim 17, wherein the current state is not specified in the experience module, wherein a similar state is not specified in the experience module, and wherein the EET value is set to 100%.
